(19) United States
(12) Patent Application Publication
(10) Pub. No.: US 2026/0109856 A1
(43) Pub. Date: Apr. 23, 2026

(54) Single-Piece Covering of Radiation Protection Materials and use Thereof

(71) Applicant: MAVIG GmbH, Muenchen (DE)

(72) Inventor: Christian STOIAN, Muenchen (DE)

(73) Assignee: MAVIG GmbH, Muenchen (DE)

(21) Appl. No.: 18/919,708

(22) Filed: Oct. 18, 2024

(30) Foreign Application Priority Data
Oct. 20, 2023 (EP) 23 204 890.0

(51) Int. Cl. C08L 75/02; C08J 3/24; C08J 5/18; C08K 3/08; C08K 5/053; C08K 5/18; C08K 5/29; C08L 7/00; C08L 9/00; C08L 15/02; C08L 75/04

(52) U.S. Cl. CPC C08L 75/02; C08J 3/24; C08J 5/18; C08K 3/08; C08K 5/053; C08K 5/18; C08K 5/29; C08L 7/00; C08L 9/00; C08L 15/02; C08L 75/04; C08J 2375/02; C08J 2375/04; C08J 2407/00; C08J 2409/00; C08J 2415/02; C08K 2003/0837; C08L 2201/08

(57) ABSTRACT

Use of a single-piece covering consisting of thermosetting polymer for protecting radiation protection elements which consist of at least one radiation protection material which is formed from at least one elastomer and at least one heavy chemical element—in ionic or elemental form—wherein the chemical element is selected from lead (Pb), bismuth (Bi), tungsten (W), tin (Sn), antimony (Sb) and barium (Ba), wherein the Shore A hardness of the covering is in the range of 50 to 90, method for protecting such coverings and the enclosed radiation protection elements and fittings which are produced from radiation protection material.

### CROSS-REFERENCE TO RELATED APPLICATIONS

The present application claims priority to EP Patent Application Serial No. 23204890.0, filed Oct. 20, 2023, the disclosure of which is hereby incorporated by reference in its entirety as if fully set forth herein.

### Field

The application relates to the use of a single-piece covering (one-piece enclosure) consisting of thermosetting polymer(s) for the protection of radiation protection elements which consist of at least one elastic radiation protection material, the method for producing the covering, and the radiation protection material or radiation protection elements provided with the covering.

### BACKGROUND

Radiation sources which emit ionizing radiation are frequently used in medical, industrial and scientific facilities. This radiation, such as X-ray radiation, can have harmful biological effects on the human body and poses a considerable health risk if shielding is inadequate.

Although conventional shielding methods, such as solid walls with lead inserts or fixedly mounted lead screens, offer effective protection, they are inflexible and cannot be readily adapted to different work requirements or room layouts.

Therefore, there is a growing need for flexible, adaptable yet highly effective radiation protection fittings. Radiation protection elements, such as e.g. radiation protection slats, offer an ideal solution to this challenge. They combine the ability to effectively block high-energy radiation with the flexibility to open or close the radiation protection barrier as required. This not only enables dynamic protection against ionizing radiation, but also adaptation to specific requirements. Radiation protection slats can be used in a variety of ways, e.g. as a curtain or as under-table radiation protection, in which the slats are mounted on a patient table. Examples of slats and the use thereof are disclosed in DE 10 2009 025 380 A1 and DE 10 2015 208 829 A1.

It is known that radiation protection elements have a cover, inter alia for hygienic reasons and for the protection of the radiation protection material. The coverings of radiation protection materials which are described in the prior art and are used in practice consist of thermoplastic films (e.g. PVC or thermoplastic polyurethanes (TPU)). This covering, often designed as a type of pocket, is produced by connecting at least 2 sides of shaped film parts together (e.g. by heat sealing or other treatment). It is important that the film parts are connected in an airtight manner so that the radiation protection element is hermetically sealed. However, the connection points of the film parts, e.g. the weld seams, are very sensitive to mechanical stress and so the coverings open up, particularly at the joints. If such covers are damaged, the radiation protection element must be replaced. Recycling of the element is often difficult.

In addition to the problem with the joints, the production of the enclosed radiation protection elements is also complex because care must be taken when enclosing the elements to ensure that no wrinkles are formed and that no air pockets are produced. In particular, air pockets can lead to premature aging of the radiation protection material, primarily due to oxidation processes. EP 3748652 A1 describes such a covering and a method for producing enclosed radiation protection elements, in which the above-mentioned problems of wrinkling and air pockets are avoided.

However, the described method for enclosing radiation protection materials and elements also has the disadvantage that the covering has a weak point on the connection lines.

A further problem when enclosing with thermoplastic polymers is that, when sealing the seams, the air-tightness is ensured only when there are no loose particles on the films to be sealed. However, the radiation protection material is treated with talcum, in particular if the matrix consists of natural rubber. In order to avoid any defects in sealing tightness in the covering, the surface of the material to be enclosed must be cleaned.

### SUMMARY

The present application represents in particular an alternative to and further development of the technologies described in EP 3748 652 A1 and EP 1613 217 A1. As far as the use of the enveloped radiation protection elements is concerned, reference is hereby made to these applications in their entirety.

The invention thus relates to a method for single-piece enclosing of radiation protection elements produced from radiation protection material, using thermosetting, solvent-free polymers having a Shore A hardness (measured according to DIN 53505) in the range of 50 to 90, the use of such polymers for enclosing these radiation protection elements, the radiation protection element enclosed with such polymers and radiation protection devices or fittings produced from the enclosed elements, as described herein and/or in the independent claims and dependent claims.

In one embodiment [A], the invention thus relates to the use of a single-piece covering consisting of thermosetting polymer(s) for the protection of radiation protection elements which consist of at least one radiation protection material which is formed from at least one elastomer and at least one heavy chemical element—in ionic or elemental form—wherein the chemical element is selected from lead (Pb), bismuth (Bi), tungsten (W), tin (Sn), antimony (Sb) and barium (Ba).

The polymer covering is elastic and has a Shore A hardness in the range of 50 to 90, preferably in the range of 60 to 70. Therefore, the radiation protection material is surrounded, and so to speak encapsulated, by the thermosetting polymer.

For elastomers and deformable synthetic materials, the Shore hardness test is a simple and effective method of material testing and a simple method of hardness measurement. The measurement according to Shore is known and defined in part in DIN standards. Essentially, a hardness tester is used which measures the penetration depth and time of a specifically shaped penetration body (indenter) and from that the hardness of the material is determined.

In one embodiment [B], the invention relates to the use as defined in embodiment [A], wherein the thermosetting polymer is a polyurea or a polyurethane, in which at least one polyisocyanate compound is used as a hardening agent. Preferably, aromatic polyureas are used because they dry more quickly during production. More preferably, solvent-free two-component systems are used.

In one embodiment [C], the invention relates to the use according to any one of the preceding embodiments, wherein the layer thickness of the thermosetting polymer is at most 2 mm, preferably at most 1 mm, particularly preferably at most 0.6 mm.

In one embodiment [D], the invention relates to the use according to any one of the preceding embodiments, wherein the cross-linking agent of the polymer is selected among aliphatic or aromatic diamine or polyamine compounds and aliphatic or aromatic diol or polyol compounds.

In one embodiment [E], the invention relates to the use according to any one of the preceding embodiments, wherein the polymer contains additives, such as fillers, UV filters, color pigments.

In one embodiment [F], the invention relates to use according to any one of the preceding embodiments, characterized in that the heavy chemical element is lead or bismuth and the elastomer is selected from natural rubber (NR), synthetic rubber (BR) or chlorosulfonated polyethylene (CSM), in each case optionally vulcanized.

In one embodiment [G], the invention relates to a radiation protection element, which is enclosed with thermosetting polymer and consists of radiation shielding material, as defined in any one of the embodiments which in this case are directed to the use or the method, wherein the covering is in one piece and has a thickness of less than or equal to 2 mm, preferably less than or equal to 1 mm, particularly preferably less than or equal to 0.6 mm.

In one embodiment [H], the invention relates to a radiation protection element as defined in embodiment [G], wherein the elastomer of the radiation protection material is selected from natural rubber (NR), synthetic rubber (BR) and chlorosulfonated polyethylene (CSM) which are each optionally vulcanized.

In one embodiment [I], the invention relates to a radiation protection element as defined in embodiment [H], wherein the heavy chemical element is lead or bismuth.

In one embodiment [J], the invention relates to a radiation protection element as defined in any one of the embodiments [G] to [I], wherein the Shore A hardness of the radiation protection material is in the range of 50-70 and/or has a lead equivalent value of at least 0.5 mm lead.

In one embodiment [K], the invention relates to a radiation protection element as defined in any one of embodiments [G] to [J], wherein the element is a slat for under-table radiation protection or for a curtain. A curtain consisting of such slats represents a radiation protection fitting. In particular, the element can be a vertical slat for curtains as well as a cassette cover or a cover angle.

In contrast to the film pockets of the prior art, the enclosure (covering) forms a mechanically integral component of the overall system and therefore new fastening methods, without riveting or screwing—i.e. drilling through—the protective material, such as clamping, are also allowed.

In one embodiment [L], the invention relates to a method for producing a radiation protection element as defined in any one of embodiments [G] to [K], comprising the following method steps:
step (1) providing the radiation protection material comprising an elastomer and a heavy chemical element, optionally in sheet form, wherein the elastomer is natural rubber (NR), synthetic rubber (BR) or chlorosulfonated polyethylene (CSM) and wherein the heavy element is selected from lead (Pb), bismuth (Bi), tungsten (W), tin (Sn), antimony (Sb) and barium (Ba);
step (2) processing, cutting or punching out the radiation protection material in the shape of the radiation protection element;
step (3) enclosing the element by simultaneous application of the cross-linking agent and the hardening agent, and optionally additives, as defined in any one of the preceding embodiments, wherein the application is optionally performed as a hot spraying method using a multi-component high pressure device, wherein the thickness of the covering is less than or equal to 2 mm, preferably less than or equal to 1 mm, particularly preferably less than or equal to 0.6 mm, and has a Shore A hardness which is in the range from 50 to 90.

In one embodiment [M], the invention relates to a method for producing a radiation protection element as defined in embodiment [L], wherein the elements consisting of radiation protection material are provided for the covering and step (2) is omitted.

In one embodiment [N], the invention relates to a method for producing a radiation protection element, as defined in embodiment [L] or [M], wherein the element is a slat for a curtain. In particular, the element can be a vertical slat for curtains or under-table radiation protection fittings, as well as a cassette cover or a cover angle.

In one embodiment [O], the invention relates to a radiation protection element which is produced by a method, as defined in one of embodiments [L] to [N].

### DETAILED DESCRIPTION

The thermosetting polymers in accordance with the invention are characterized by their high resistance to chemicals, extreme temperatures and physical stress.

The radiation protection material contains at least one heavy chemical element—in ionic or elemental form, wherein the chemical element is selected from lead (Pb), bismuth (Bi), tungsten (W), tin (Sn), antimony (Sb) and barium (Ba). Lead and bismuth are preferred, lead is particularly preferred.

The invention renders it possible to provide coverings which do not need connection points, e.g. weld seams, and thus avoid the disadvantages of the prior art. The covering is produced directly after curing of the applied polymer components (cross-linking agent (base) and hardening agent) on the radiation protection material to be enclosed or the elements produced therefrom. The covering also has a high degree of abrasion resistance and elongation at fracture.

The covering in accordance with the invention consisting of cross-linked thermosetting polymer is seamless and is thus also referred to in this case as a single-piece covering. The radiation protection material is hermetically enclosed by the cover.

A multi-component high pressure device is typically used for the method. In this method, the components A and B (and further additives) are heated and atomized under high pressure. Upon exiting the nozzle, the two components are mixed at the surface. The material cures to a touch-dry state in a short time.

The reaction time is less than 30 seconds and the coating is touch-dry after less than 5 minutes. Hard-drying takes longer, i.e. approximately 24 hours. After drying, a further layer can be applied in order to protect e.g. against UV radiation or in order to achieve the desired color or brilliance.

The thermosetting polymers in accordance with the invention, such as in particular polyureas and polyurethanes, are produced by the polymerization of at least two components, namely a base (a cross-linking agent, component A) and a hardening agent (component B) immediately after application to the radiation protection material or the elements consisting thereof.

The advantage of the single-piece covering resides not only in the simplicity of production but primarily also in the fact that there are no connection points which can tear open. Moreover, the radiation protection material to be enclosed does not require any pre-treatment, in that e.g. the surfaces of the elements consisting of radiation protection material specifically do not have to have any substances arising from the production process removed therefrom.

This can be e.g. talcum if so-called lead rubber is used as the radiation protection material. In the case of multi-piece thermoplastic coverings according to the prior art, talcum regularly produces defects in sealing tightness at the connection points because impurities are present in the connection point during sealing.

By means of the single-piece covering, the radiation protection material is effectively protected against oxidation and rapid aging and has a long service life. Equally, unintended contamination with substances which are potentially harmful to health (e.g. heavy metals, lead, bismuth etc.) is minimized or precluded. The coating can also be mechanically loaded and is easy to clean.

The inventive use of thermosetting polymers to enclose radiation protection material and elements produced therefrom has thus far not been known.

Furthermore, by reason of the method for producing the coverings, it is preferred to use such cross-linking agents and hardening agents which are liquid at room temperature or melt at temperatures up to 250° C. without decomposition.

Amongst the polyureas which can be used, those consisting of aromatic polyamines as cross-linking agents are preferred.

Amongst the polyurethanes which can be used, those having aliphatic polyols as cross-linking agents are preferred.

The covering in accordance with the invention can likewise contain additives which provide e.g. UV protection.

Radiation protection materials are materials which are capable of blocking or absorbing harmful ionizing radiation, such as e.g. X-ray radiation. These radiation protection materials contain at least one type of the following heavy chemical elements, such as lead (Pb), bismuth (Bi), tungsten (W), tin (Sn), antimony (Sb) and barium (Ba). The elements are typically embedded into a polymer matrix. They can consist of various materials. Polymer matrixes in accordance with the invention comprise thermosetting elastomers, in particular polyureas which are optionally vulcanized.

The radiation protection material can also be present in the form of composite materials, in which various radiation protection materials are combined in order to achieve a lower weight and a high level of wearing comfort while having an adequate lead equivalent value.

In the present invention, lead rubber is preferably used. It is an elastomer material which consists mainly of a polymer matrix which is interspersed or charged with lead powder or lead particles (lead in elemental or oxidized form), wherein the lead serves mainly to modify the elastomer material with regard to its radiation-absorbing properties.

The elastomer, i.e. the elastic component, can be natural rubber (NR), synthetic rubber (BR) or chlorosulfonated polyethylene (CSM). Other rubbers which have a Shore A hardness comparable to natural rubber are also possible.

Natural rubber (NR) has inter alia a high degree of elasticity, cold flexibility and excellent dynamic properties. However, without being correspondingly provided with protective additives, the resistance to aging and ozone is only low and, moreover, natural rubber is not resistant to contact with mineral oils and fats.

NR is provided for the hardness ranges of Shore A 30-90. CSM is available for the hardness ranges of Shore A 45 to 90.

In one embodiment of the invention, a lead rubber single layer material is produced which is suitable for use as radiation protection elements, in particular as vertical slats for curtains, or under-table radiation protection fittings and as cassette covers, cover angles and the like. This lead rubber single layer material comprises a radiation protection matrix, in particular a lead-containing and sulfur-cross-linked lead rubber plate and the covering produced with the thermosetting polymer in accordance with the invention.

The material consisting of lead-containing rubber can optionally have a central, optionally friction-glazed tissue insert and can have additional coatings. The material has preferably a lead equivalent value in the range of 0.5 to 2.00 mm lead, the Shore A hardness is typically in the range of 50 to 70.

The radiation protection material is processed to form elements, these elements are joined together to form radiation protection arrangements. Such a radiation protection arrangement can be e.g. a curtain or it can be a lower body protection arrangement. The radiation protection arrangements can be fastened, e.g. in front of a window or to at least one lateral region of a treatment table. This radiation protection arrangement, in particular if it is a lower body protection arrangement, consists of an upper part which is arranged on a carrier rail fastened to the place of use (e.g. table), and of a plurality of slats which are fastened to the underside of the carrier rail and are arranged to overlap laterally next to one another. Such an arrangement is illustrated in FIG. 1 in EP 1613217 B1.

In one embodiment, the lead protection material is present in the form of (curtain) slats. These slats are mounted on curtain tracks. They consist of specific materials, such as e.g. aluminum. The track carriage of such slatted curtains has a stable track carriage, formed preferably on hard synthetic material. The slat receiver is manufactured from material which can be subjected to very heavy loading, e.g. carbon fibers.

1. Use of a single-piece covering comprising thermosetting polymer for protecting radiation protection elements which comprise at least one radiation protection material which is formed from at least one elastomer and at least one heavy chemical element—in ionic or elemental form—wherein the chemical element is selected from lead (Pb), bismuth (Bi), tungsten (W), tin (Sn), antimony (Sb) and barium (Ba), wherein the Shore A hardness of the covering is in the range of 50 to 90.

2. The use as claimed in claim 1, wherein the thermosetting polymer is a polyurea or a polyurethane, in which at least one polyisocyanate compound is used as a hardening agent.

3. The use as claimed in claim 1, wherein the layer thickness of the thermosetting polymer is less than or equal to 2 mm.

4. The use as claimed in claim 1, wherein the cross-linking agent of the polymer is selected among aliphatic or aromatic diamine or polyamine compounds and aliphatic or aromatic diol or polyol compounds.

5. The use as claimed in claim 1, wherein the polymer contains additives, such as fillers, UV filters, color pigments.

6. The use as claimed in claim 1, wherein the heavy chemical element is lead or bismuth and the elastomer is selected from vulcanized natural rubber (NR), not vulcanized natural rubber (NR), synthetic rubber (BR), or chlorosulfonated polyethylene (CSM).

7. A radiation protection element, which is enclosed with thermosetting polymer and comprises radiation protection material, as defined in claim 1, wherein the covering is formed in one piece and has a thickness of less than or equal to 2 mm.

8. The radiation protection element as claimed in claim 7, wherein the elastomer of the radiation protection material is selected from natural rubber (NR), synthetic rubber (BR) and chlorosulfonated polyethylene (CSM).

9. The radiation protection material as claimed in claim 8, wherein the heavy chemical element is lead or bismuth.

10. The radiation protection element as claimed in claim 7, wherein the Shore A hardness of the radiation protection material is in the range of 50 to 70 and/or has a lead equivalent value of at least 0.5 mm lead.

11. The radiation protection element as claimed in claim 7, wherein the element is a slat for under-table radiation protection or for a curtain, or is a cassette cover or a cover angle.

12. A method for producing an enclosed radiation protection element as defined claim 7, comprising the method steps of:
(1) providing the radiation protection material comprising an elastomer and a heavy chemical element, wherein the elastomer is natural rubber (NR), synthetic rubber (BR) or chlorosulfonated polyethylene (CSM) and wherein the heavy element is selected from lead (Pb), bismuth (Bi), tungsten (W), tin (Sn), antimony (Sb) and barium (Ba);
(2) machining, cutting or punching the radiation protection material in the shape of the radiation protection element;
(3) enclosing the element by simultaneous application of the cross-linking agent and the hardening agent, wherein the thickness of the covering is less than or equal to 2 mm, and has a Shore A hardness which is in the range from 50 to 90.

13. (canceled)

14. The method as claimed in claim 12, wherein the element is a slat for under-table radiation protection or for a curtain, or is a cassette cover or a cover angle.

15. A radiation protection element produced by a method as claimed in claim 12.

16. The method as claimed in claim 12, wherein the heavy chemical element is in sheet form.

17. The method as claimed in claim 12, wherein enclosing the element by simultaneous application of the cross-linking agent and the hardening agent includes application of additives.

18. The method as claimed in claim 12, wherein the application is performed with a multi-component high pressure device as a hot spraying method.

19. A method for producing an enclosed radiation protection element, comprising the method steps of:
providing the radiation protection material comprising an elastomer and a heavy chemical element, wherein the elastomer is natural rubber (NR), synthetic rubber (BR) or chlorosulfonated polyethylene (CSM) and wherein the heavy element is selected from lead (Pb), bismuth (Bi), tungsten (W), tin (Sn), antimony (Sb) and barium (Ba);
enclosing the element by simultaneous application of the cross-linking agent and the hardening agent, wherein the thickness of the covering is less than or equal to 2 mm, and has a Shore A hardness which is in the range from 50 to 90.

20. The method of claim 19, further comprising: machining, cutting or punching the radiation protection material in the shape of the radiation protection element.
